(19) United States
(12) Patent Application Publication
(10) Pub. No.: US 2020/0073043 A1
(43) Pub. Date: Mar. 5, 2020

(54) LIGHT GUIDING STRUCTURE AND MANUFACTURING METHOD THEREOF, LIGHT SOURCE ASSEMBLY AND DISPLAY DEVICE

(71) Applicants: HEFEI BOE OPTOELECTRONICS TECHNOLOGY CO., LTD., Hefei (CN); BOE TECHNOLOGY GROUP CO., LTD., Beijing (CN)

(72) Inventors: Jingbin JIE, Beijing (CN); Liang GAO, Beijing (CN); Hai TANG, Beijing (CN); Bing ZHANG, Beijing (CN); Lu GAO, Beijing (CN); Xiaolin GENG, Beijing (CN)

(21) Appl. No.: 16/407,652

(22) Filed: May 9, 2019

(30) Foreign Application Priority Data
Sep. 3, 2018 (CN) 201811021276.2

(51) Int. Cl. F21V 8/00; G02F 1/1334

(52) U.S. Cl. CPC G02B 6/0035; G02F 1/1334; G02B 6/0065; G02B 6/0055; G02B 6/0076

(57) ABSTRACT

A light guiding structure, a manufacturing method thereof, a light source assembly and a display device are provided. The light guiding structure includes a first light guiding layer including a light emitting surface and a first surface, and a second light guiding layer including a second surface. The light emitting surface includes a first inclined surface having a first angle with respect to the first surface. A second inclined surface is on a side of the second surface away from the first light guiding layer and has a second angle with respect to the second surface. Refractive indexes of the first and second light guiding layers are respectively n₁ and n₂, n₁>n₂; a direction of light, which enters the second light guiding layer after being reflected by the first inclined surface, and is incident to and reflected by the second inclined surface, is substantially perpendicular to the first surface.

The present application claims priority to Chinese patent application No. 201811021276.2, filed on Sep. 3, 2018, the entire disclosure of which is incorporated herein by reference as part of the present application.

### TECHNICAL FIELD

At least one embodiment of the present disclosure relates to a light guiding structure and a manufacturing method thereof, a light source assembly and a display device.

### BACKGROUND

With the development of information technology and the wide application of Internet, information security is becoming increasingly important. Electronic products such as mobile phones and tablet computers, used in public places such as commercial places, subways and buses, are needed to have a function of peep prevention to protect business secrets and privacy. However, in a case where a user needs to share display content with a plurality of people, electronic products such as mobile phones and tablet computers are needed to be displayed at a wide viewing angle.

### SUMMARY

At least one embodiment of the present disclosure provides a light guiding structure, the light guiding structure includes a first light guiding layer and a second light guiding layer. The first light guiding layer includes a light emitting surface, a flat first surface opposite to the light emitting surface, and a light incident surface intersecting the light emitting surface and the first surface, the light emitting surface includes a first inclined surface, and the first inclined surface has a first angle with respect to the first surface; the second light guiding layer includes a second surface, and the second surface is parallel to and attaches to the first surface. The light guiding structure further includes a second inclined surface disposed on a side of the second surface facing away from the first light guiding layer, the second inclined surface has a second angle with respect to the second surface; a refractive index of a material of the first light guiding layer is n1, a refractive index of a material of the second light guiding layer is n2, and n1>n2; the first inclined surface and the second inclined surface are configured to allow a direction of light, which enters the second light guiding layer after being reflected by the first inclined surface, and is incident to the second inclined surface, and then is reflected by the second inclined surface, is substantially perpendicular to the first surface.

For example, in the light guiding structure of at least one embodiment of the present disclosure, the second light guiding layer includes a reflective surface opposite to the second surface, and the reflective surface includes the second inclined surface.

For example, the light guiding structure of at least one embodiment of the present disclosure further includes a third light guiding layer, the second light guiding layer includes an opposite surface that is opposite to and parallel to the second surface, the third light guiding layer includes a third surface parallel to and attaching to the opposite surface and a reflective surface opposite to the third surface, the reflective surface comprises the second inclined surface; a refractive index of a material of the third light guiding layer is n3, n3>n2; the first inclined surface and the second inclined surface are configured to allow the direction of the light, which enters the second light guiding layer after being reflected by the first inclined surface, and passes through the second light guiding layer, and is incident to the second inclined surface, and then is reflected by the second inclined surface, is substantially perpendicular to the first surface.

For example, in the light guiding structure of at least one embodiment of the present disclosure, the second angle is less than ½*arcsin(n2/n3).

For example, in the light guiding structure of at least one embodiment of the present disclosure, a distance from the first inclined surface to the first surface in a direction from an end of the first inclined surface close to the light incident surface to an end of the first inclined surface facing away from the light incident surface gradually decreases; a distance from the second inclined surface to the second surface in a direction from an end of the second inclined surface close to the light incident surface to an end of the second inclined surface facing away from the light incident surface gradually decreases.

For example, in the light guiding structure of at least one embodiment of the present disclosure, the light emitting surface comprises a plurality of first inclined surfaces, the light emitting surface further includes a plurality of flat portions, each of the plurality of flat portions is parallel to the first surface, and at least one of the plurality of flat portions is between two adjacent first inclined surfaces of the plurality of the first inclined surfaces.

For example, in the light guiding structure of at least one embodiment of the present disclosure, the light guiding structure comprises a plurality of second inclined surfaces, and no flat portion parallel to the second surface is between two adjacent second inclined surfaces of the plurality of the second inclined surfaces.

For example, the light directing structure of at least one embodiment of the present disclosure further includes a reflective layer in contact with the second inclined surface.

For example, in the light guiding structure of at least one embodiment of the present disclosure, the first angle is between 0.5 and 5 degrees.

For example, the light guiding structure of at least one embodiment of the present disclosure further includes a third inclined surface intersecting with the second inclined surface. The third inclined surface has a third angle with respect to the second surface, and the third angle is between 60 and 90 degrees.

For example, in the light guiding structure of at least one embodiment of the present disclosure, a length of the first inclined surface is between 30 and 200 μm from an end of the first inclined surface close to the light incident surface to an end of the first inclined surface facing away from the light incident surface; and a length of the second inclined surface is between 20 and 100 μm from an end of the second inclined surface close to the light incident surface to an end of the second inclined surface facing away from the light incident surface.

For example, in the light guiding structure of at least one embodiment of the present disclosure, the second inclined surface is a mirror surface.

At least one embodiment of the present disclosure further provides a light source assembly, the light source assembly includes a light emitting portion, a light adjustment structure, and the light guiding structure provided by at least one embodiment of the present disclosure, the light emitting portion faces the light incident surface of the light guiding structure so that light emitted from the light emitting portion enters the light incident surface of the light guiding structure; and the light adjustment structure faces the light emitting surface of the light guiding structure and is configured that light emitted from the light emitting surface is switched between a convergence state and a divergence state.

For example, in the light source assembly provided by at least one embodiment of the present disclosure, the light adjustment structure includes a polymer dispersed liquid crystal (PDLC) layer.

At least one embodiment of the present disclosure further provides a display device includes the light source assemblies provided by at least one embodiment of the present disclosure.

At least one embodiment of the present disclosure further provides a method of fabricating a light guiding structure, the method includes: forming a first light guiding layer, in which the first light guiding layer comprises a light emitting surface, a first surface opposite to the light emitting surface, and a light incident surface intersecting with the light emitting surface and the first surface, and the light emitting surface comprises the first inclined surface having a first angle with respect to the first surface; forming a second light guiding layer, in which the second light guiding layer comprises a second surface that is parallel to and attaches to the first surface; and forming a second inclined surface on a side of the second surface facing away from the first light guiding layer, the second inclined surface has a second angle with respect to the second surface; a refractive index of a material of the first light guiding layer is n1, a refractive index of a material of the second light guiding layer is n2, and n1>n2; the first inclined surface and the second inclined surface are configured to allow a direction of light, which enters the second light guiding layer after being reflected by the first inclined surface, and is incident to the second inclined surface, and then is reflected by the second inclined surface, is substantially perpendicular to the first surface.

For example, in the method of fabricating the light guiding structure provided by at least one embodiment of the present disclosure, the forming the second inclined surface includes forming a reflective surface on the second light guiding layer opposite to the second surface, and the reflective surface comprises the second inclined surface.

For example, the method of fabricating the light guiding structure provided by at least one embodiment of the present disclosure further includes forming a third light guiding layer, in which the second light guiding layer includes an opposite surface that is opposite to and parallel to the second surface; the third light guiding layer includes a third surface parallel to and attaching to the opposite surface and a reflective surface opposite to the third surface, the reflective surface includes the second inclined surface; a refractive index of a material of the third light guiding layer is n3, n3>n2; the first inclined surface and the second inclined surface are configured to allow the direction of the light, which enters the second light guiding layer after being reflected by the first inclined surface, and passes through the second light guiding layer, and is incident to the second inclined surface, and then is reflected by the second inclined surface, is substantially perpendicular to the first surface.

For example, the method of fabricating the light directing structure of at least one embodiment of the present disclosure further includes forming a reflective layer in contact with the second inclined surface.

For example, in the method of fabricating the light directing structure of at least one embodiment of the present disclosure, the first inclined surface and the second inclined surface are formed by a nano-imprinting method or a photolithography method or an injection molding method.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1A is a schematic cross-sectional view of a light guiding structure according to at least one embodiment of the present disclosure;

FIG. 1B is another schematic cross-sectional view of the light guiding structure according to at least one embodiment of the present disclosure;

FIG. 1C is still another schematic cross-sectional view of the light guiding structure according to at least one embodiment of the present disclosure;

FIG. 2 is a diagram of optical simulation results of the light guiding structure according to at least one embodiment of the present disclosure;

FIG. 3A is a schematic cross-sectional view of a light source assembly in a narrow viewing angle state according to at least one embodiment of the present disclosure;

FIG. 3B is a schematic cross-sectional view of the light source assembly in a wide viewing angle state according to at least one embodiment of the present disclosure;

FIG. 4 is another schematic cross-sectional view of the light source assembly according to at least one embodiment of the present disclosure;

FIG. 5 is a schematic diagram of a display device according to at least one embodiment of the present disclosure;

FIGS. 6A-6E are schematic diagrams illustrating a method of fabricating the light guiding structure according to at least one embodiment of the present disclosure;

FIGS. 7A-7C are another schematic diagrams of the method of fabricating the light guiding structure according to at least one embodiment of the present disclosure; and

FIGS. 8A-8D are still another schematic views of the method of fabricating the light guiding structure according to at least one embodiment of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. It is obvious that the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., which are used in the description and the claims of the present application, are not intended to indicate any sequence, amount or importance, but distinguish various components. The terms “comprise,” “comprising,” “include,” “including,” etc., are intended to specify that the elements or the objects stated before these terms encompass the elements or the objects and equivalents thereof listed after these terms, but do not preclude the other elements or objects. “On,” “under,” “right,” “left” and the like are only used to indicate relative position relationship, and when the position of the object which is described is changed, the relative position relationship may be changed accordingly.

The dimensions of the drawings in the present disclosure are not strictly drawn according to the actual scale, the number of the first inclined surfaces in the light guiding structure is not limited to the number shown in the drawings, and the specific size and number of each structure may be determined according to actual needs. The structures and optical paths in the drawings of the present disclosure are only schematic structural diagrams.

At least one embodiment of the present disclosure provides a light guiding structure, the light guiding structure includes a first light guiding layer and a second light guiding layer. The first light guiding layer includes a light emitting surface, a flat first surface opposite to the light emitting surface, and a light incident surface intersecting with the light emitting surface and the first surface, the light emitting surface includes a first inclined surface, the first inclined surface has a first angle with respect to the first surface; the second light guiding layer includes a second surface, the second surface is parallel to and attaches to the first surface. The light guiding structure further includes a second inclined surface disposed on a side of the second surface facing away from the first light guiding layer, the second inclined surface has a second angle with respect to the second surface; a refractive index of a material of the first light guiding layer is n1, and a refractive index of a material of the second light guiding layer is n2, n1>n2; a direction of light, which enters the second light guiding layer after being reflected by the first inclined surface, and is incident to the second inclined surface, and then is reflected by the second inclined surface, is substantially perpendicular to the first surface.

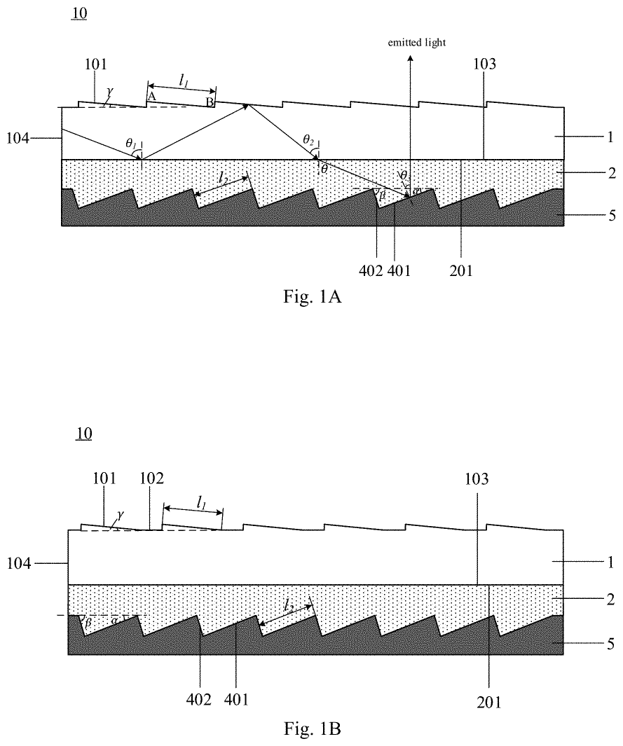

Exemplarily, FIG. 1A is a schematic cross-sectional view of the light guiding structure according to at least one embodiment of the present disclosure. As shown in FIG. 1A, the light guiding structure 10 includes a first light guiding layer 1 and a second light guiding layer 2. The first light guiding layer 1 includes a light emitting surface, a flat first surface 103 opposite to the light emitting surface, and a light incident surface intersecting with the light emitting surface and the first surface 103, the light emitting surface includes a first inclined surface 101, the first inclined surface 101 has a first angle γ with respect to the first surface 103; the second light guiding layer 2 includes a second surface 201, the second surface 201 is parallel to and attaches to the first surface 103. For example, the light emitting surface includes a plurality of first inclined surfaces 101. For example, the plurality of first inclined surfaces 101 are continuously arranged so that no flat portion parallel to the first surface 103 is between two adjacent first inclined surfaces 101 of the plurality of first inclined surfaces 101. The light guiding structure 10 further includes a second inclined surface 401 disposed on a side of the second surface 201 facing away from the first light guiding layer 1, the second inclined surface 401 has a second angle α with respect to the second surface 201. Both the first inclined surface 101 and the second inclined surface 401 reflect light. A material of the first light guiding layer 1 and a material of the second light guiding layer 2 are light transmitting materials such as transparent materials. A refractive index of the material of the first light guiding layer is n1, and a refractive index of the material of the second light guiding layer is n2, n1>n2. The first inclined surface 101 and the second inclined surface 401 are configured to allow a direction of light, which enters the second light guiding layer 2 after being reflected by the first inclined surface 101, and is incident to the second inclined surface 401, and then is reflected by the second inclined surface 401, is substantially perpendicular to the first surface 103. The flat first surface 103 refers to that an entirety of the first surface 103 is provided in a same plane, and the first surface 103 does not include a deliberately formed protrusion protruding out the first surface 103 and/or a deliberately formed inclined surface having an angle with respect to the first surface 103, other than unavoidable unevenness caused by the manufacturing precision. For example, the first surface 103 is substantially parallel to a base substrate in a case where the light guiding structure 10 is disposed in a display device including the base substrate. Therefore, the light emitted from the light emitting surface of the light guiding structure 10 is substantially perpendicular to the first surface 103, and a light emitting angle (i.e. an angle between the light emitted from the light emitting surface and a direction perpendicular to the first surface 103) is reduced. For example, the display device using the light guiding structure 10 has a narrow viewing angle, and thus a function of peep prevention is realized.

For example, in the embodiment illustrated in FIG. 1A, the second light guiding layer 2 includes a reflective surface opposite to the second surface 201, and the reflective surface includes the second inclined surface 401. That is, the second inclined surface 401 is located at the reflective surface, opposite to the second surface 201, of the second light guiding layer 2. The reflective surface is capable of reflective light.

Next, a propagation process of light in the light guiding structure 10 shown in FIG. 1A and a principle of realizing the narrow viewing angle will be described. An incident angle is θ1 when light propagates in the first light guiding layer 1 and is incident on an interface of the first light guiding layer 1 and the second light guiding layer 2; since n1>n2, the light is totally reflected onto the first inclined surface 101 of the light emitting surface if the incident angle θ1 is greater than a critical angle at the interface of the first light guiding layer 1 and the second light guiding layer 2, and a total reflection occurs again on the first inclined surface 101; the incident angle is θ2 when light is incident again on the interface of the first light guiding layer 1 and the second light guiding layer 2, θ2<θ1, that is, since the first inclined surface 101 has the first angle γ with respect to the first surface 103, the first inclined surface 101 has an adjustment effect on an propagation direction of light to reduce the incident angle of the light incident on the interface between the first light guiding layer 1 and the second light guiding layer 2 until the incident angle is less than the critical angle at the interface between the first light guiding layer 1 and the second light guiding layer 2; the light enters the second light guiding layer 2 and is incident on the second inclined surface 401, and then is reflected by the second inclined surface 401, and the direction of the light reflected by the second inclined surface 401 is substantially perpendicular to the first surface 103. As such, the light guiding structure 10 reduces the light emitting angle. For example, the display device using the light guiding structure 10 has the narrow viewing angle, and thus the function of peep prevention is realized.

For example, the material of the first light guiding layer 1 and the material of the second light guiding layer 2 are both a transparent organic material, for example, a resin material such as an ultraviolet curable resin. For example, n1=1.49, n2=1.35. For example, the material of the first light guiding layer 1 is polymethyl methacrylate (PMMA), and the material of the second light guiding layer 2 is an ultraviolet curable adhesive having a refractive index of 1.35. Those skilled in the art may select according to the actual situation, as long as n1>n2 is satisfied.

For example, in a direction from an end of the first inclined surface 101 close to the light incident surface 104 to an end of the first inclined surface 101 facing away from the light incident surface 104, a distance (i.e., a perpendicular distance) from the first inclined surface 101 to the first surface 103 gradually decreases; in a direction from an end of the second inclined surface 401 close to the light incident surface 104 to an end of the second inclined surface 401 facing away from the light incident surface 104, a distance (i.e., perpendicular distance) from the second inclined surface 401 to the second surface 201 gradually decreases. In this way, most of the light incident on the interface between the first light guiding layer 1 and the second light guiding layer 2 have the optical path shown in FIG. 1A described above, thereby realizing that the direction of the light emitted from the light emitting surface is substantially perpendicular to the first surface 103.

For example, as shown in FIG. 1A, the light guiding structure comprises a plurality of second inclined surfaces 401, and no flat portion parallel to the second surface 201 is between two adjacent second inclined surfaces 401 of the plurality of the second inclined surfaces 401. That is, the plurality of second inclined surfaces 401 are continuously arranged, and a portion parallel to the second surface 201 is not between the adjacent two second inclined surfaces 401 of the plurality of the second inclined surfaces 401. In this way, it is ensured that the light incident at any position is incident on the second inclined surface 401 and is reflected by the second inclined surface 401, so that the direction of the light emitted from any position of the light emitting surface of the light guiding structure 10 is substantially perpendicular to the first surface 103 to obtain a better effect of narrow viewing angle.

For example, the second inclined surface 401 is a mirror surface so that the light incident on the second inclined surfaces 401 is specularly reflected to improve the utilization efficiency of light.

For example, the light guiding structure 10 further includes a reflective layer 5 that is in contact with the second inclined surfaces 401. The reflective layer 5 enables the second inclined surfaces 401 to have a higher reflectance, so as to reduce light loss, and improve light utilization; furthermore, the reflective layer 5 protects the second inclined surface 401. For example, the reflective layer 5 is a prism, and a surface of the prism is a mirror surface having a high reflectance. Alternatively, the reflective layer 5 is a metal reflective film formed of a metal material. The metal material is, for example, aluminum, copper, silver or the like. Surely, the metal material used to form the reflective layer 5 is not limited to the above-listed types, and the material of the reflective layer is not limited in the embodiments of the present disclosure.

For example, the first angle γ is 0.5°˜5°. In this case, the incident angle of the light incident on the interface between the first light guiding layer 1 and the second light guiding layer 2 after the light being reflected by the first inclined surface 101 decreases by 1°˜10°, that is, the first inclined surface 101 finely adjusts the direction of the incident light incident on the interface between the first light guiding layer 1 and the second light guiding layer 2 (i.e., the adjustment amplitude is small), so that the light, with the incident angle being slightly less than the critical angle at the interface between the first light guiding layer 1 and the second light guiding layer 2, enters the second light guiding layer 2 and then is incident on the second inclined surface 401, so as to ensure that the direction of the light finally emitted from the light emitting surface hardly deviates from the direction perpendicular to the first surface 103, which is advantageous to obtain a better narrow viewing angle effect. If the first angle γ is too small, it is disadvantageous to allow the incident angle of light to be less than the above critical angle, which is disadvantageous for allowing the light to be incident on the second inclined surfaces 401; if the first angle γ is too large, the adjustment amplitude of the incident angle of the light incident on the interface between the first light guiding layer 1 and the second light guiding layer 2 is too large, so that the direction of the light emitted from the light emitting surface may be deviated from the direction perpendicular to the first surface 103 to a great extent, which is disadvantageous for obtaining a better narrow viewing angle effect.

For example, the light guiding structure 10 further includes a third inclined surface 402 intersecting with the second inclined surface 401, the third inclined surface 402 has a third angle β with respect to the second surface 201, and the third angle β is 60°˜90°. If the third angle β is too small, a part of the light entering the second light guiding layer 2 is incident on the third inclined surface 402, thereby blocking the incidence of light entering the second light guiding layer 2 on the second inclined surfaces 401, it is disadvantageous to obtain the desired light whose emitting direction is substantially perpendicular to the first surface 103.

For example, as shown in FIG. 1A, a length 11 of the first inclined surface 101 from the end A of the first inclined surface 101 close to the light incident surface 104 to the end B of the first inclined surface 101 facing away from the light incident surface 104 is 30˜200 μm; and a length 12 of the second inclined surfaces 401 from the end of the second inclined surfaces 401 close to the light incident surface 104 to the end of the second inclined surfaces 401 facing away from the light incident surface 104 is 20˜100 μm, so as to achieve a better light adjustment effect.

For example, in another embodiment of the present disclosure, the light emitting surface further includes a plurality of flat portions, at least one of the plurality of flat portions is located between two adjacent first inclined surfaces of the plurality of first inclined surfaces. Exemplarily, FIG. 1B is another schematic cross-sectional view of the light guiding structure according to at least one embodiment of the present disclosure. As shown in FIG. 1B, the light guiding structure 10 is different from the light guiding structure shown in FIG. 1A in that the light emitting surface further includes a plurality of flat portions 102, each of the flat portions 102 is substantially parallel to the first surface 103, each of the plurality of flat portions 102 is located between two adjacent first inclined surfaces 101 of the plurality of first inclined surfaces 101. Part of the light, which is incident on the first inclined surface 101 from the light incident surface 104 and is reflected by the first inclined surface 101, is transmitted to the second light guiding layer 2 and is then incident on the second inclined surfaces 401; and in this case, with the light propagating away from the light incident surface 104 of the light guiding structure 10, the light may be gradually lost, and the light intensity may be reduced. By providing the flat portion 102, such light loss is reduced, so that the brightness of each position of the light guiding structure 10 is uniform. For example, in FIG. 1B, one flat portion is between two adjacent first inclined surfaces; and in other embodiments of the present disclosure, two or three first inclined surfaces may correspond to one flat portion. The specific arrangement of the first inclined surface and the flat portion is not limited in the embodiments of present disclosure, as long as the above effects can be achieved.

Other features of the light guiding structure 10 shown in FIG. 1B are the same as those in FIG. 1A, the previous description may be referred to, and details are not described herein again.

FIG. 1C is still another schematic cross-sectional view of the light guiding structure according to at least one embodiment of the present disclosure. As shown in FIG. 1C, the light guiding structure 10 is different from the light guiding structure shown in FIG. 1B in that the light guiding structure 10 further includes a third light guiding layer 3. In this case, the second light guiding layer 2 includes an opposite surface 202 opposite to and parallel to the second surface 201; the third light guiding layer 3 includes a third surface 301 which is parallel to and attaches to the opposite surface 202, and a reflective surface opposite to the third surface 301, and the reflective surface includes the second inclined surface 401. A material of the third light guiding layer 3 is a light transmissive material, such as a transparent material. The refractive index of the material of the third light guiding layer 3 is n3, n3>n2; the first inclined surface 101 and the second inclined surface 401 are configured to allow the direction of light, which enters the second light guiding layer 2 and then pass through the second light guiding layer 2 after being reflected by the first inclined surface 101, and is incident to the second inclined surface 401, and then is reflected by the second inclined surface 401, is substantially perpendicular to the first surface 103. For example, in the light guiding structure 10 shown in FIG. 1C, the second light guiding layer 2 is an adhesive layer, and the first light guiding layer 1 and the third light guiding layer 3 are bonded each other by the second light guiding layer 2 to facilitate fabrication. In the embodiment shown in FIG. 1C, for example, the second light guiding layer 2 is an OCA (Optically Clear Adhesive). The material of the third light guiding layer 3 is the light transmissive material, for example, is the same as the material of the first light guiding layer 1. Of course, the material of the third light guiding layer 3 only needs to satisfy n3>n2, which is not limited by the embodiments of the present disclosure.

The propagation process of light in the light guiding structure shown in FIG. 1C and the principle of realizing the narrow viewing angle will be described below. In the light guiding structure 10, the incident angle is θ1 when light propagates in the first light guiding layer 1 and is incident on the interface of the first light guiding layer 1 and the second light guiding layer 2; since n1>n2, the light is totally reflected onto the first inclined surface 101 of the light emitting surface if the incident angle θ1 is greater than the critical angle at the interface of the first light guiding layer 1 and the second light guiding layer 2, and the total reflection occurs again on the first inclined surface 101; the incident angle is θ2 when the light is incident again on the interface of the first light guiding layer 1 and the second light guiding layer 2, θ2<θ1, that is, since the first inclined surface 101 has the first angle γ with respect to the first surface 103, the first inclined surface 101 has the adjustment effect on the propagation direction of light to reduce the incident angle of the light incident on the interface between the first light guiding layer 1 and the second light guiding layer 2 until the incident angle is less than the critical angle at the interface between the first light guiding layer 1 and the second light guiding layer 2; the light enters the second light guiding layer 2, passes through the second light guiding layer 2 and is incident on the interface of the second light guiding layer 2 and the third light guiding layer 3. Since it is required in the embodiment that the incident angle θ2 is slightly less than the critical angle at the interface between the first light guiding layer 1 and the second light guiding layer 2, the refraction angle θ4 of the light incident into the second light guiding layer is greater. Therefore, the incident angle θ5 of the light incident on the interface between the second light guiding layer 2 and the third light guiding layer 3 is greater; and in this case, if n3<n2, then the total reflection is easy to occur, so the embodiment of the present disclosure sets n3>n2, that is, the light is transmitted from an optical sparse medium to an optical dense medium, which prevents the light from being totally reflected at the interface between the second light guiding layer 2 and the third light guiding layer 3. Thus, the light enters the third light guiding layer 3 and is incident on the second inclined surfaces 401 and is reflected by the second inclined surfaces 401, and the direction of the light reflected by the second inclined surfaces 401 is substantially perpendicular to the first surface 103, thereby reducing the light emitting angle of the light guiding structure 10. For example, the light guiding structure 10 is applied to the display device, and the display device obtains a better peep prevention effect.

For example, in the light guiding structure 10 shown in FIG. 1C, the second angle is less than ½*arcsin(n2/n3). As shown in FIG. 1A, the incident angle is θ2, and the refraction angle is θ. In a case where the emitted light is perpendicular to the first surface 103, the calculated second angle α=θ3=½*θ=½*arcsin(n2/n3) if the incident angle θ2 is equal to the critical angle; in fact, the incident angle is less than the critical angle, so the second angle α is less than ½*arcsin(n2/n3).

Other features of the light guiding structure 10 shown in FIG. 1C are the same as those in FIG. 1B, the previous description may be referred to, and details are not described herein again.

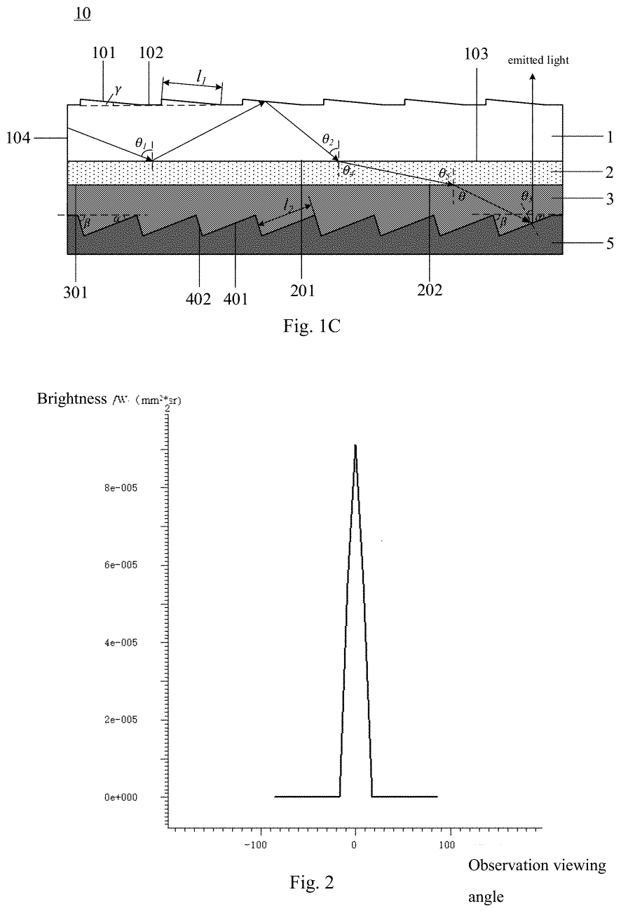

FIG. 2 is a diagram of optical simulation results of the light guiding structure according to at least one embodiment of the present disclosure. As shown in FIG. 2, the observation viewing angle (representing the angle between the light emitted from the light emitting surface and the direction perpendicular to the first surface 103) has a peak near 0°, indicating that the observation viewing angle of the light having a higher brightness is in a range near 0°, i.e., the light emitted from the light emitting surface of the light-guiding structure 10 is substantially perpendicular to the first surface 103, and the light guiding structure provided by the embodiment of the present disclosure achieves a better convergence effect, for example, the display device using the light guiding structure has a good narrow viewing angle effect.

At least one embodiment of the present disclosure further provides a light source assembly, the light source assembly includes a light emitting portion, a light adjustment structure, and the light guiding structure provided by at least one embodiment of the present disclosure, the light emitting portion faces the light incident surface of the light guiding structure such that light emitted from the light emitting portion enters the light incident surface of the light guiding structure; and the light adjustment structure faces the light emitting surface of the light guiding structure and is configured that light emitted from the light emitting surface is switched between a convergence state and a divergence state. Therefore, for example, the light source assembly is used in the display device, the display device realizes a switch between a peep prevention mode and a sharing mode.

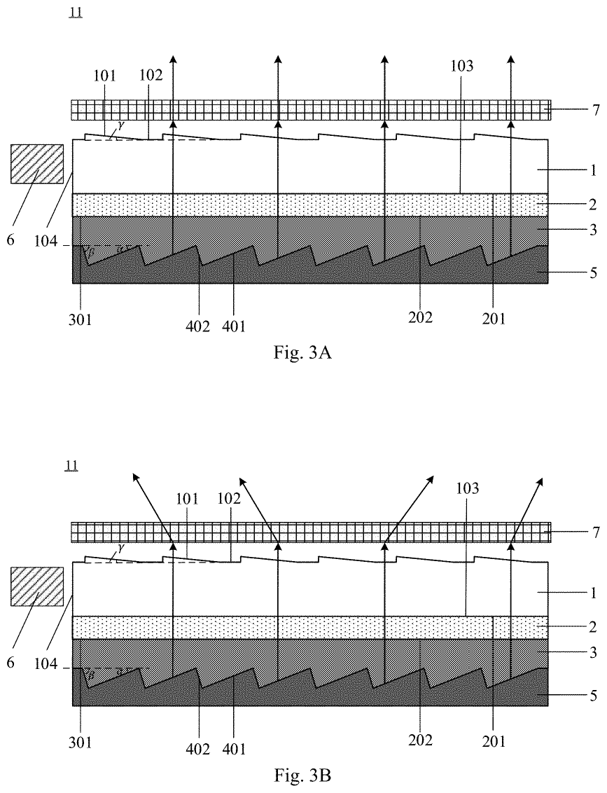

Exemplarily, FIG. 3A is a schematic cross-sectional view of the light source assembly in a narrow viewing angle state according to at least one embodiment of the present disclosure, and FIG. 3B is a schematic cross-sectional view of the light source assembly in a wide viewing angle state according to at least one embodiment of the present disclosure. The light source assembly includes any of the light guiding structures provided by the embodiments of the present disclosure, and FIG. 3A and FIG. 3B illustrate the light source assembly 11 including the light guiding structure shown in FIG. 1C as an example. As shown in FIG. 3A and FIG. 3B, the light source assembly 11 includes a light emitting portion 6, a light adjustment structure 7, and the light guiding structure 10 provided by at least one embodiment of the present disclosure, and the light-emitting portion 6 faces the light-incident surface 104 of the light-guiding structure 10 such that the light emitted from the light emitting portion 6 enters the light incident surface 104 of the light guiding structure 10. The light adjustment structure 7 faces the light emitting surface of the light guiding structure 10, and the light emitted from the light emitting surface enters the light adjustment structure 7. The light adjustment structure 7 is configured to switch the light emitted from the light emitting surface of the light guiding structure between the convergence state as shown in FIG. 3A and the divergence state as shown in FIG. 3B.

For example, the light adjustment structure is a polymer dispersed liquid crystal (PDLC) layer. The liquid crystal molecules in the PDLC layer are used as optical switches, and the emission direction of the light entering the PDLC layer is controlled by applying a voltage to the liquid crystal molecules in the PDLC layer to control the deflection direction of the liquid crystal molecules. As shown in FIG. 3A, an optical axis of the liquid crystal molecules is substantially perpendicular to the first surface 103 of the light guiding structure, that is, the optical axis of the liquid crystal molecules substantially coincides with the direction of the light emitted from the light guiding structure; the light adjustment structure does not change the direction of the light so that the light emitted from the light adjustment structure is in the convergence state; in this case, the light source assembly 11 is used in the display device, the display device is in the narrow viewing angle state. As shown in FIG. 3B, the optical axis of the liquid crystal molecules is deflected and is not perpendicular to the first surface 103 of the light guiding structure, that is, the optical axis of the liquid crystal molecules has an angle with respect to the direction of the light emitted from the light emitting surface; the light adjusting structure changes the direction of the light so that the light emitted from the light adjustment structure is in the divergence state; in this case, the light source assembly 11 is used in the display device, the display device is in the wide viewing angle state. The degree of divergence of light is adjusted by adjusting the deflection angle of the liquid crystal molecules according to actual needs. The light-adjustment structure may be a structure other than the PDLC layer, as long as the light emitted from the light emitting surface of the light guiding structure is switched between the convergence state and the divergence state, which is not limited in the embodiments of the present disclosure.

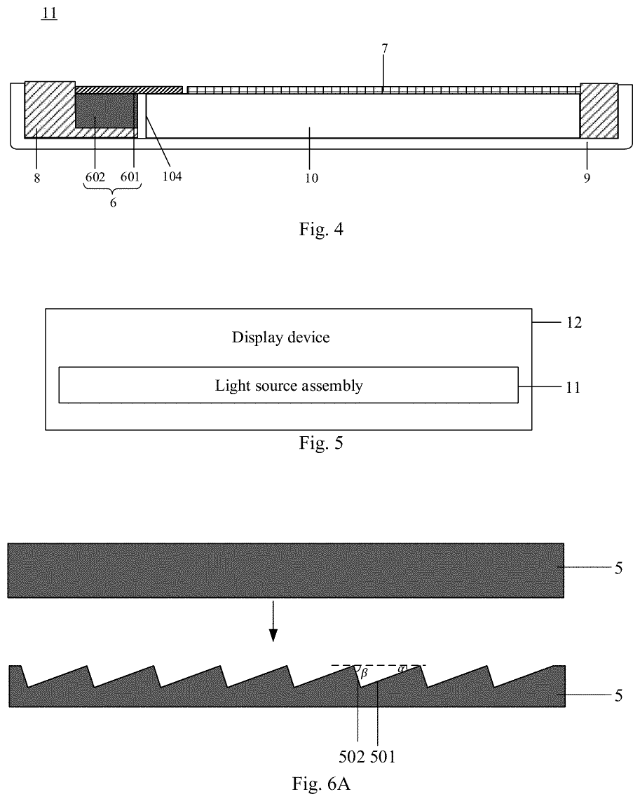

FIG. 4 is another schematic structural diagram of the light source assembly according to at least one embodiment of the present disclosure. As shown in FIG. 4, for example, the light source assembly 11 further includes a sealant 8 and a back plate 9. The light emitting portion 6 and the light guiding structure 10 are fixed on the back plate 9. For example, the light emitting portion 6 and the light guiding plate 10 are bonded to the back plate 9 by a fixing tape. The sealant 8 fixes and protects components of the light source assembly, for example, the light emitting portion 6. For example, the light emitting portion 6 includes a substrate 601 and a light emitting element 602. The light emitting element 602 is fixed on the substrate 601, a portion of the substrate 601 covers an end, close to the light emitting portion 6, of the light emitting surface of the light guiding structure 10, and the substrate 601 is opaque. The intensity of light near the light emitting portion 6 and at the end, close to the light emitting portion 6, of the light guiding structure 10 is high, and it is necessary to provide a light shielding tape above the light emitting portion 6 and the end, close to the light emitting portion 6, of the light guiding structure 10. For example, the light source assembly 11 is applied to the display panel, the light shielding tape avoids the brightness of the portion of the display panel corresponding to the end, close to the light emitting portion 6, of the light guiding structure 10 from being too high. In the light source assembly provided by at least one embodiment of the present disclosure, the opaque substrate 601 covers the end, close to the light emitting portion 6, of the light emitting surface of the light guiding structure 10, so that the substrate 601 simultaneously has a light shielding effect, and thus, the light shielding tape provided above the light emitting portion 6 and the end, close to the light emitting portion 6, of the light guiding structure 10 is omitted, the structure of the light source assembly 11 is simplified, the assembly process of the light source assembly 11 is simplified, and the cost is saved. For example, a material of the substrate 601 is white, which has a weak absorption ability for light and a strong reflection light for light and thus is advantageous for improving the utilization efficiency of light. For example, an epoxy resin or a resin doped with a white pigment is used. For example, the material of the substrate 601 may be other colors than white, such as resins doped with pigments of different colors. For example, the substrate 601 includes a printed circuit board which is, for example, opaque. Of course, the material of the substrate 601 is not limited to the ones listed above, as long as it is an opaque material.

At least one embodiment of the present disclosure further provides a display device, and the display device includes the light source assembly provided by at least one embodiment of the present disclosure.

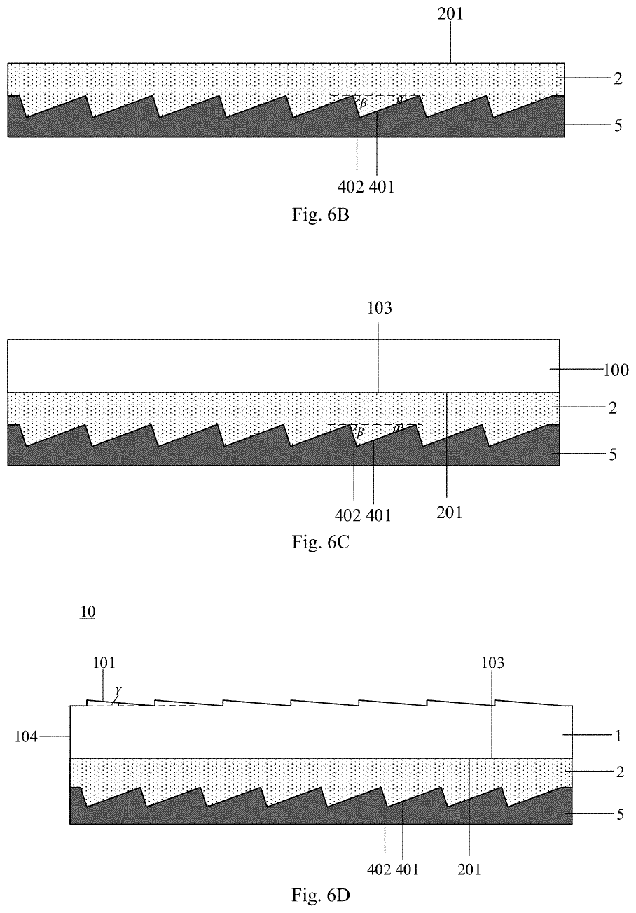

For example, FIG. 5 is a schematic diagram of the display device according to at least one embodiment of the present disclosure. As shown in FIG. 5, the display device 12 includes the light source assembly 11 provided by at least one embodiment of the present disclosure. For example, the display device may be any display device which requires a backlight, such as a liquid crystal display device. For example, the display device may be implemented as any product or component which requires a display function of the peep prevention state and the sharing state, such as a mobile phone, a tablet computer, a display, a notebook computer, an ATM machine, or the like.

At least one embodiment of the present disclosure further provides a method of fabricating the light guiding structure, the method includes: forming the first light guiding layer, in which the first light guiding layer comprises the light emitting surface, the first surface opposite to the light emitting surface, and the light incident surface intersecting with the light emitting surface and the first surface, and the light emitting surface comprises the first inclined surface having the first angle with respect to the first surface; forming the second light guiding layer, in which the second light guiding layer comprises the second surface that is parallel to and attaches to the first surface; and forming the second inclined surface on the side of the second surface facing away from the first light guiding layer, the second inclined surface has the second angle with respect to the second surface; the refractive index of the material of the first light guiding layer is n1, the refractive index of the material of the second light guiding layer is n2, and n1>n2; the first inclined surface and the second inclined surface are configured to allow the direction of light, which enters the second light guiding layer after being reflected by the first inclined surface, and is incident to the second inclined surface, and then is reflected by the second inclined surface, is substantially perpendicular to the first surface.

For example, the forming the second inclined surface includes forming the reflective surface on the second light guiding layer opposite to the second surface, and the reflective surface comprises the second inclined surface.

For example, the fabricating method further includes forming the reflective layer in contact with the second inclined surface.

For example, the reflective layer is formed first, and then the second light guiding layer is formed on the reflective layer.

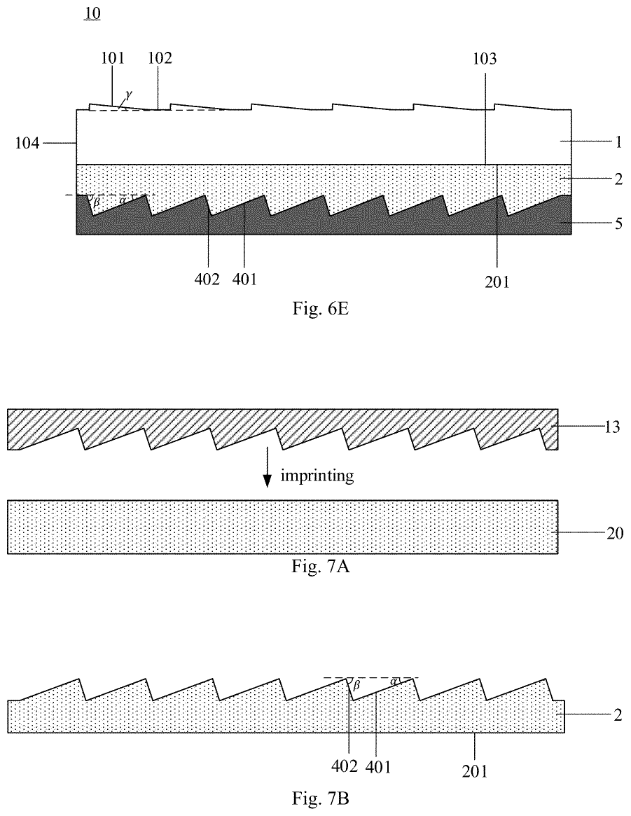

Exemplarily, FIGS. 6A-6E are schematic diagrams showing the method of fabricating the light guiding structure according to at least one embodiment of the present disclosure. As shown in FIG. 6A, the reflective layer 5 is formed by patterning a reflective material layer 501 for forming the reflective layer 5, the reflective layer 5 includes the reflective surface, and the reflective surface includes a first reflective surface 501 having a same shape as the second inclined surface and a third reflective surface 502 having a same shape as the third inclined surface. The patterning process is, for example, a photolithography process or a nano-imprinting process or an injection molding process. Then, as shown in FIG. 6B, the second light guiding layer 2 is formed on the reflective surface of the reflective layer 5, for example, by a coating or deposition method. The second light guiding layer 2 includes the second surface 201 and the reflective surface opposite to the second surface 201, and the reflective surface includes the second inclined surfaces 401. That is, the second inclined surface 401 is located at the reflective surface of the second light guiding layer 2 opposite to the second surface 201. The reflective surface is capable of reflective light. For the materials of the reflective layer 5 and the second light guiding layer 2, the description of the embodiments above may be referred to.

As shown in FIG. 6C, after curing the second light guiding layer 2, a first material layer 100 for forming the first light guiding layer 1 is formed on the second light guiding layer 2. For example, the first material layer 100 is formed by the coating or deposition method.

As shown in FIG. 6D, the first material layer 100 is patterned to form a pattern of the light emitting surface of the first light guiding layer 1. The first light guiding layer 1 includes the light emitting surface, the flat first surface 103 opposite to the light emitting surface, and the light incident surface intersecting with the light emitting surface and the first surface 103, the light emitting surface includes the first inclined surface 101, the first inclined surface 101 has the first angle γ with respect to the first surface 103. The second surface 201 of the second light guiding layer 2 is parallel to and attaches to the first surface 103 of the first light guiding layer 1. For example, the first inclined surface 101 is formed by the photolithography process or the nano-imprinting process or the injection molding process. For example, the pattern of the light emitting surface is shown in FIG. 6D, and the light emitting surface includes a plurality of first inclined surfaces 101, the plurality of first inclined surfaces 101 are continuously arranged, that is, no flat portion parallel to the first surface 103 is between two adjacent first inclined surfaces 101 of the plurality of first inclined surfaces 101. Thereby, the light guiding structure 10 shown in FIG. 1A is formed. For another example, the pattern of the light emitting surface is shown in FIG. 6E, the light emitting surface further includes a plurality of flat portions 102, each of the plurality of flat portions 102 is substantially parallel to the first surface 103, and each of the plurality of flat portions 102 is located between two adjacent first inclined surfaces 101 of the plurality of first inclined surfaces 101. The light guiding structure 10 shown in FIG. 1B is formed. For the material of the first light guiding layer 1, the description of the embodiment above may be referred to. The refractive index of the material of the first light guiding layer is n1, the refractive index of the material of the second light guiding layer is n2, and n1>n2. The first inclined surface 101 and the second inclined surface 401 are configured to allow the direction of light, which enters the second light guiding layer 2 after being reflected by the first inclined surface 101, and is incident to the second inclined surface 401, and then is reflected by the second inclined surface 401, is substantially perpendicular to the first surface 103. For other features of the light guiding structure 10, the description of the embodiments shown in FIG. 1A and FIG. 1B may be referred to, and details are not described herein again.

For example, in another embodiment of the present disclosure, the second light guiding layer including the second inclined surface is formed first, and then the reflective layer is formed on the second inclined surface.

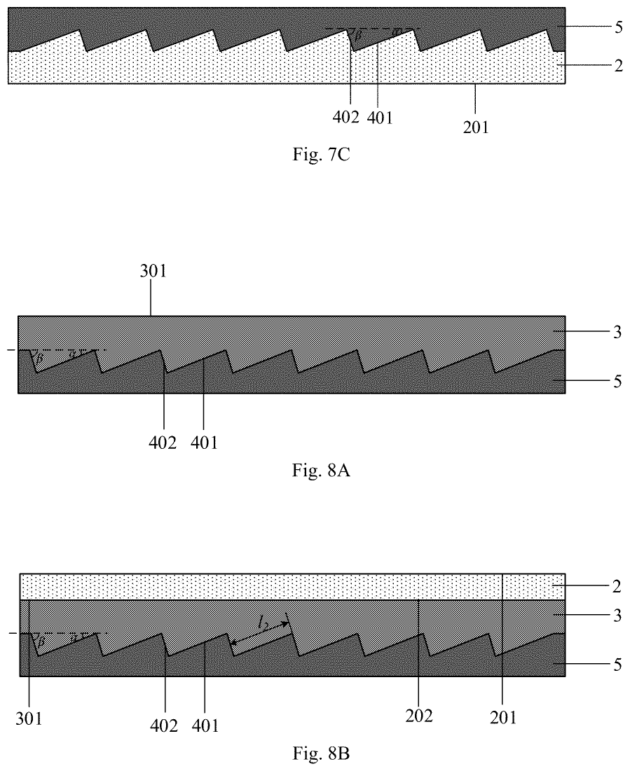

Exemplarily, FIGS. 7A-7C are another schematic diagrams of the method of fabricating the light guiding structure according to at least one embodiment of the present disclosure. As shown in FIG. 7A, a patterning process is performed on the second material layer 20 for forming the second light guiding layer 2 to form the second light guiding layer 2 as shown in FIG. 7B, and the description in the previous embodiments for the structural features of the second light guiding layer 2 may be referred to, and details are not described herein again. For example, the patterning process is the nano-imprinting process in which the second material layer 20 is embossed by a mold 13 having a shape of the second inclined surface. Of course, in other embodiments, the patterning process may be the photolithography process or the injection molding process.

As shown in FIG. 7C, the reflective layer 5 is formed on the second inclined surfaces 401, and the reflective layer 5 is formed, for example, by an evaporation method. Then, the steps of FIGS. 6C-6E are performed, and the light guiding structure 10 shown in FIGS. 1A and 1B is obtained.

For example, the method of fabricating the light guiding structure provided by at least one embodiment of the present disclosure further includes forming the third light guiding layer, the second light guiding layer includes the opposite surface that is opposite to and parallel to the second surface; the third light guiding layer includes the third surface parallel to and attaches to the opposite surface and the reflective surface opposite to the third surface, the reflective surface includes the second inclined surface; the refractive index of the material of the third light guiding layer is n3, n3>n2; the first inclined surface and the second inclined surface are configured to allow the direction of the light, which enters the second light guiding layer after being reflected by the first inclined surface, and is incident to the second inclined surface through the second light guiding layer, and then is reflected by the second inclined surface, is substantially perpendicular to the first surface.

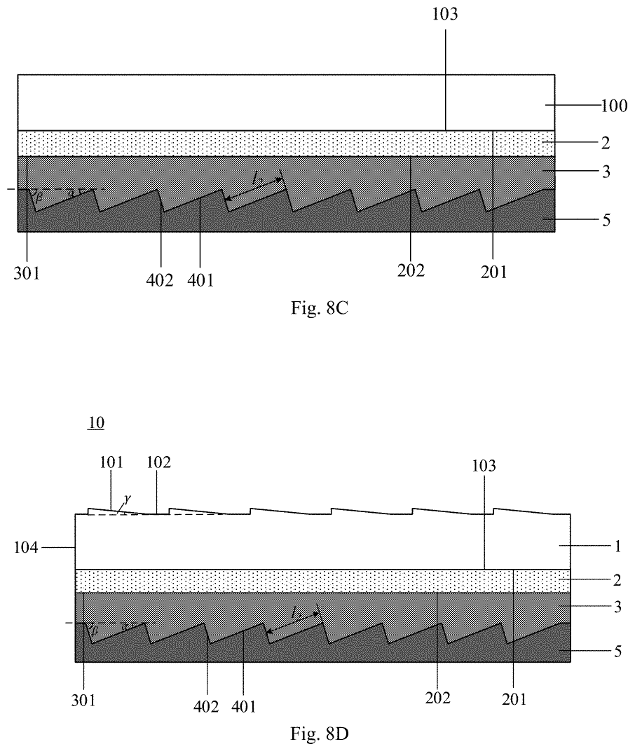

Exemplarily, FIGS. 8A-8D are still another schematic views of the method of fabricating the light guiding structure according to at least one embodiment of the present disclosure. As shown in FIG. 8A, by using the method shown in FIGS. 6A-6B or the method shown in FIGS. 7A-7C, the reflection layer 5 including the inclined surface having the same shape as that of the second reflection surface 401 is formed and then the third light guiding layer 3 is formed on the reflective layer 5, or the third reflective layer 3 including the second inclined surfaces 401 is first formed and then the reflective layer 5 is formed on the second inclined surfaces 401 of the third light guiding layer 3, thereby obtaining the structure in FIG. 8A. The third light guiding layer 3 includes the third surface 301 and the reflective surface opposite to the third surface 301, and the reflective surface includes the second inclined surface 401 and the third inclined surface 402.

As shown in FIG. 8B, the second light guiding layer 2 is formed on the third light guiding layer 3, for example, the second light guiding layer 2 is formed by the coating or deposition method, and the second light guiding layer 2 includes the second surface 201 and the opposite surface 202 opposite to and parallel to the second surface 201 such that the third surface 301 is parallel and attaches to the opposite surface 202. Alternatively, the second light guiding layer 2 is the OCA (Optically Clear Adhesive), and the opposite surface 202 of the second light guiding layer 2 is adhered to the third surface 301.

As shown in FIG. 8C, the first material layer 100 for forming the first light guiding layer 1 is formed on the second light guiding layer 2. For example, the first material layer 100 is formed by the coating or deposition method. In the case where the second light guiding layer 2 needs to be cured, the step shown in FIG. 8C is performed after the second light guiding layer 2 is cured.

As shown in FIG. 8D, the first material layer 100 is patterned to form the pattern of the light emitting surface of the first light guiding layer 1, thereby the light guiding structure 10 shown in FIG. 1C is formed. The first light guiding layer 1 includes the light emitting surface, the flat first surface 103 opposite to the light emitting surface, and the light incident surface intersecting with the light emitting surface and the first surface 103, the light emitting surface includes the first inclined surface 101, the first inclined surface 101 has the first angle γ with respect to the first surface 103. For example, the first inclined surface 101 is formed by the photolithography process or the nano-imprinting process or the injection molding process. Other features of the first light guiding layer 1 are the same as those in the previous embodiments. In the embodiment shown in FIGS. 8A-8D, the third light guiding layer 3 is the light transmissive material, such as the transparent material. The refractive index of the material of the third light guiding layer 3 is n3, n3>n2; the first inclined surface 101 and the second inclined surface 401 are configured to allow the direction of light, which enters the second light guiding layer 2 after being reflected by the first inclined surface 101, and then passes through the second light guiding layer 2, and is incident to the second inclined surface 401, and then is reflected by the second inclined surface 401, is substantially perpendicular to the first surface 103. The material of the first light guiding layer 1, the material of the second light guiding layer 2 and the specific material of the third light guiding layer 3 are same or similar as those described in the previous embodiments.

What are described above is related to the illustrative embodiments of the disclosure only and not limitative to the scope of the disclosure; the scopes of the disclosure are defined by the accompanying claims.

What is claimed is:

1. A light guiding structure, comprising:
a first light guiding layer comprising a light emitting surface, a flat first surface opposite to the light emitting surface, and a light incident surface intersecting with the light emitting surface and the first surface, the light emitting surface comprising a first inclined surface, the first inclined surface having a first angle with respect to the first surface; and
a second light guiding layer comprising a second surface, the second surface being parallel to and attaching to the first surface,
wherein the light guiding structure comprises a second inclined surface disposed on a side of the second surface facing away from the first light guiding layer, the second inclined surface has a second angle with respect to the second surface;
a refractive index of a material of the first light guiding layer is n1, a refractive index of a material of the second light guiding layer is n2, and n1>n2;
the first inclined surface and the second inclined surface are configured to allow a direction of light, which enters the second light guiding layer after being reflected by the first inclined surface, and is incident to the second inclined surface, and then is reflected by the second inclined surface, is substantially perpendicular to the first surface.

2. The light guiding structure according to claim 1, wherein the second light guiding layer comprises a reflective surface opposite to the second surface, and the reflective surface comprises the second inclined surface.

3. The light guiding structure according to claim 1, further comprising: a third light guiding layer,
wherein the second light guiding layer comprises an opposite surface that is opposite and parallel to the second surface;
the third light guiding layer comprises a third surface parallel to and attaching to the opposite surface of the second light guiding layer, and a reflective surface opposite to the third surface, and the reflective surface comprises the second inclined surface;
a refractive index of a material of the third light guiding layer is n3, n3>n2;
the first inclined surface and the second inclined surface are configured to allow the direction of the light, which enters the second light guiding layer after being reflected by the first inclined surface, and passes through the second light guiding layer, and is incident to the second inclined surface, and then is reflected by the second inclined surface, is substantially perpendicular to the first surface.

4. The light guiding structure according to claim 3, wherein the second angle is less than ½*arcsin(n2/n3).

5. The light guiding structure according to claim 1, wherein
a distance from the first inclined surface to the first surface in a direction from an end of the first inclined surface close to the light incident surface to an end of the first inclined surface facing away from the light incident surface gradually decreases; and
a distance from the second inclined surface to the second surface in a direction from an end of the second inclined surface close to the light incident surface to an end of the second inclined surface facing away from the light incident surface gradually decreases.

6. The light guiding structure according to claim 1, wherein
the light emitting surface comprises a plurality of first inclined surfaces,
the light emitting surface further comprises a plurality of flat portions, each of the plurality of flat portions is parallel to the first surface, and
at least one of the plurality of flat portions is between two adjacent first inclined surfaces of the plurality of the first inclined surfaces.

7. The light guiding structure according to claim 1, wherein
the light guiding structure comprises a plurality of second inclined surfaces, and
no flat portion parallel to the second surface is between two adjacent second inclined surfaces of the plurality of the second inclined surfaces.

8. The light directing structure according to claim 1, further comprising: a reflective layer in contact with the second inclined surface.

9. The light guiding structure according to claim 1, wherein the first angle is between 0.5 and 5 degrees.

10. The light guiding structure according to claim 9, further comprising: a third inclined surface intersecting with the second inclined surface, wherein
the third inclined surface has a third angle with respect to the second surface, and the third angle is between 60 and 90 degrees.

11. The light guiding structure according to claim 1, wherein
a length of the first inclined surface is between 30 and 200 m from an end of the first inclined surface close to the light incident surface to an end of the first inclined surface facing away from the light incident surface; and
a length of the second inclined surface is between 20 and 100 min from an end of the second inclined surface close to the light incident surface to an end of the second inclined surface facing away from the light incident surface.

12. The light guiding structure according to claim 2, wherein
a distance from the first inclined surface to the first surface in a direction from an end of the first inclined surface close to the light incident surface to an end of the first inclined surface facing away from the light incident surface gradually decreases;
a distance from the second inclined surface to the second surface in a direction from an end of the second inclined surface close to the light incident surface to an end of the second inclined surface facing away from the light incident surface gradually decreases.

13. The light guiding structure according to claim 3, wherein
a distance from the first inclined surface to the first surface in a direction from an end of the first inclined surface close to the light incident surface to an end of the first inclined surface facing away from the light incident surface gradually decreases;
a distance from the second inclined surface to the second surface in a direction from an end of the second inclined surface close to the light incident surface to an end of the second inclined surface facing away from the light incident surface gradually decreases.

14. A light source assembly, comprising: a light emitting portion, a light adjustment structure, and a light guiding structure, wherein
the light guiding structure comprises:
a first light guiding layer comprising a light emitting surface, a flat first surface opposite to the light emitting surface, and a light incident surface intersecting with the light emitting surface and the first surface, the light emitting surface comprising a first inclined surface, the first inclined surface having a first angle with respect to the first surface; and
a second light guiding layer comprising a second surface, the second surface being parallel to and attaching to the first surface,
the light guiding structure comprises a second inclined surface disposed on a side of the second surface facing away from the first light guiding layer, the second inclined surface has a second angle with respect to the second surface;
a refractive index of a material of the first light guiding layer is n1, a refractive index of a material of the second light guiding layer is n2, and n1>n2;
the first inclined surface and the second inclined surface are configured to allow a direction of light, which enters the second light guiding layer after being reflected by the first inclined surface, and is incident to the second inclined surface, and then is reflected by the second inclined surface, is substantially perpendicular to the first surface;
the light emitting portion faces the light incident surface of the light guiding structure so that light emitted from the light emitting portion enters the light incident surface of the light guiding structure; and
the light adjustment structure faces the light emitting surface of the light guiding structure and is configured that light emitted from the light emitting surface is switched between a convergence state and a divergence state.

15. The light source assembly according to claim 14, wherein the light adjustment structure comprises a polymer dispersed liquid crystal layer.

16. A display device, comprising the light source assembly according to claim 14.

17. A method of fabricating a light guiding structure, comprising:
forming a first light guiding layer, wherein the first light guiding layer comprises a light emitting surface, a flat first surface opposite to the light emitting surface, and a light incident surface intersecting with the light emitting surface and the first surface, and the light emitting surface comprises a first inclined surface having a first angle with respect to the first surface;
forming a second light guiding layer, wherein the second light guiding layer comprises a second surface that is parallel to and attaches to the first surface; and
forming a second inclined surface on a side of the second surface facing away from the first light guiding layer, the second inclined surface having a second angle with respect to the second surface, wherein
a refractive index of a material of the first light guiding layer is n1, a refractive index of a material of the second light guiding layer is n2, and n1>n2; the first inclined surface and the second inclined surface are configured to allow a direction of light, which enters the second light guiding layer after being reflected by the first inclined surface, and is incident to the second inclined surface, and then is reflected by the second inclined surface, is substantially perpendicular to the first surface.

18. The method of fabricating the light guiding structure according to claim 17, wherein the forming the second inclined surface comprises: forming a reflective surface on the second light guiding layer opposite to the second surface, and the reflective surface comprising the second inclined surface.

19. The method of fabricating the light guiding structure according to claim 17, further comprising:
forming a third light guiding layer, wherein the second light guiding layer comprises an opposite surface that is opposite to and parallel to the second surface, the third light guiding layer comprises a third surface parallel to and attaching to the opposite surface of the second light guiding layer and a reflective surface opposite to the third surface, and the reflective surface comprises the second inclined surface; a refractive index of a material of the third light guiding layer is n3, n3>n2; the first inclined surface and the second inclined surface are configured to allow the direction of the light, which enters the second light guiding layer after being reflected by the first inclined surface, and passes through the second light guiding layer, and is incident to the second inclined surface, and then is reflected by the second inclined surface, is substantially perpendicular to the first surface.

20. The method of fabricating the light guiding structure according to claim 17, wherein the first inclined surface and the second inclined surface are formed by a nano-imprinting method or a photolithography method or an injection molding method.
